(19) United States
(12) Patent Application Publication
(10) Pub. No.: US 2006/0190399 A1
(43) Pub. Date: Aug. 24, 2006

(54) Data processing technique for providing a cash rebate in a loan program

(76) Inventor: Milton B. Silverman, Santa Ana, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/064,451

(22) Filed: Feb. 22, 2005

(51) Int. Cl. G06Q 40/00

(52) U.S. Cl. 705/40

(57) ABSTRACT

A method provides a cash rebate in a loan program of a financial institution using a computer having a memory device. The method includes maintaining, in the memory device of the computer, for a borrower, a borrower information file, including a contractual loan payback schedule based on an interest rate calculated in accordance with a current credit score of the borrower, a principal amount, a initial interest amount, and a loan term. The payback transaction data is stored in the memory device of the computer during the loan term. The transaction data is compiled as a payback record at the end of the term. A final credit score is calculated in accordance with the quality of the payback record as related to the payback schedule. A new interest amount is calculated based on the final credit score. A cash rebate is issued to the borrower as the difference between the initial interest amount and the final interest amount.

### RELATED APPLICATIONS

None

### BACKGROUND OF THE INVENTION

1. Field of the Invention

This invention relates generally to data processing method used by financial institutions, and more particularly to those data processing methods related to loans made to their clients where such loans require payback of principal and interest according to a payback schedule.

2. Description of Related Art

The following art defines the present state of this field and each disclosure is hereby incorporated herein by reference:

Kern et al., U.S. 2002/0161630, discloses a method and apparatus for reducing the balance of a consumer or educational loan obligation using a loyalty reward program. Loan obligors can reduce the balances of their loan obligations by purchasing consumer goods and services that they would normally purchase. The method essentially comprises the steps of (a) establishing a site on a global computer network; (b) recognizing at least certain users of the site; (c) directing the recognized users to merchants; (d) enabling accumulation of loyalty points by the recognized users based upon purchases from the merchants; (e) monitoring the purchases by the recognized users from the merchants; (f) tracking the accumulated loyalty points; and (g) permitting selective redemption of the accumulated loyalty points. Users of the site are recognized by requiring them to provide initial registration information. Accumulated loyalty points may be categorized with a status of “pending” or a status of “earned.” Selective redemption of the accumulated loyalty points includes selective application of earned loyalty points to a loan of a recognized user to permit repayment of the loan, or selective transfer of earned loyalty points from one recognized user to another recognized user. Information about accumulated, redeemed, and transferred loyalty points may be displayed to a recognized user.

Sanchez et al., U.S. 2002/0188533, discloses methods, systems, and articles of manufacture consistent with certain principles related to the present invention allow a financial account provider to provide a financial account with parameters that may be adjusted based on payment activities of the account. The financial account provider may monitor the payment activity for the account, such as consecutive payments, on time payments, missed payments, late payments, etc., and adjust the account parameters accordingly. In one configuration consistent with the present invention, the financial account provider may increase an interest rate for the account when a payment is received late. Alternatively, the customer may increase an account limit and/or decrease the interest rate for the account when the provider received a certain number of consecutive on-time payments.

King, U.S. Pat. No. 5,742,775, discloses an operatively interconnected data processing and computing system that is provided for creating, servicing and paying loan agreements between a lender and borrower providing for repayment of the loan together with interest at a periodically adjusted rate based on the terms of the agreement.

Hucal, U.S. Pat. No. 5,933,817, discloses a method and a system for operating a revolving credit program utilizing a table of tiered interest rates in which one of the interest rates is applied as a finance charge to a remaining outstanding balance of an account depending upon the percentage that payments made during a billing cycle comprise of an account parameter, such as the outstanding balance, a highest balance or a beginning balance. In the preferred embodiment the applied interest rate is determined by the percentage the outstanding balance is reduced by payments on the balance during a billing cycle. Also in a preferred embodiment of the invention, the tiered interest rate table is structured to apply progressively reduced interest rates to outstanding balances reduced by progressively greater payment percentages from the previous billing cycle, thereby encouraging a credit customer to make larger payments and pay down the outstanding balance faster. Also in the preferred embodiment, the system calculates and displays the minimum payments necessary to reduce the outstanding balance to meet each tier of the interest rate table.

Mumick et al., U.S. Pat. No. 6,006,207, discloses a method and system of implementing a loan in a billing system that includes memory storing information relating to the loan, the information including a principal balance of the loan, a term of the loan, and an interest rate of the loan. A prepayment amount that is a portion of the principal balance of the loan is selected. A present value of the prepayment amount is determined and a discount amount is selected. A discounted prepayment amount is determined based on the prepayment amount and the present value of the prepayment amount. The discount amount may be less than, equal to or greater than the difference between the prepayment amount and the present value of the prepayment amount. The discount amount may be greater than the difference, for example, for promotional purposes. A discounted prepayment amount that is the prepayment amount less the discount amount is determined and a discounted prepayment offer is transmitted to the customer of the loan, the discounted prepayment offer including an indication of the discounted prepayment amount. The discounted prepayment is received from the customer of the loan and the prepayment amount is deducted from the principal balance of the loan.

King, U.S. Pat. No. 6,148,293, discloses an operatively interconnected data processing and computing system that is provided for creating, servicing and paying loan agreements between a lender and borrower providing for repayment of the loan together with interest at a periodically adjusted rate based on the terms of the agreement. The system includes data processing for a novel form of relationship management links, supervising and balancing the interests of contract holders, marketing agents, financial intermediaries, investment managers, investment bankers, custodians, rating agencies and an issuing entity.

Shurling et al., U.S. Pat. No. 6,424,951, discloses a Relationship scoring and Incentive Reward awarding process that determines a Relationship score for the Relationships between a Bank and each of its customers. Such Relationships may include deposit accounts, loan accounts, and customer referrals. Customer data describing the Relationship between the Bank and its customers is furnished by the customers and extracted from a Bank customer information file. Incentive Rewards, such as reduced loan rates or increased deposit account interest, are awarded to customers based on the Relationship scores. Management reports summarize the Relationships between the Bank and its customers and provide marketing information.

Kelly, WO 01/24095, discloses computer-based method and system for controlling the mortgage rate charged to a mortgagee as a prevailing mortgage rate drops. Using an Automatic Rate Cut (ARC) mortgage, a customer's interest rate may be reduced without going through a traditional refinance process. The ARC Loan offers a model of financing for both purchasing or refinancing property (e.g., a residence). Once the customer has been in the program for a specified period since settlement date, the interest rate can be modified down provided that interest rates have declined since the customer entered the ARC Loan. Secondary conditions can also be used to determine if the mortgage qualifies for a rate reduction.

Our prior art search with abstracts described above teaches the use of incentives by financial lenders for improving the performance of borrowers in loan payback agreements. However, the prior art fails to teach a program whereby a borrower is provided a cash rebate of a portion of the interest already paid to the lender at the termination of a payback period (term), where the cash rebate is based on the credit score of the borrower at the end of the payback period. The present invention fulfills these needs and provides further related advantages as described in the following summary.

### SUMMARY OF THE INVENTION

The present invention teaches certain benefits in construction and use which give rise to the objectives described below.

In the best mode preferred embodiment of the present financial method invention, a cash rebate is provided in a loan program of a financial institution using a computer having a memory device. The method includes maintaining, in the memory device of the computer, for a borrower, a borrower information file, including a contractual loan payback schedule based on an interest rate calculated in accordance with a current credit score of the borrower, a principal amount, a initial interest amount, and a loan term. The payback transaction data is stored in the memory device of the computer during the loan term. The transaction data is compiled as a payback record at the end of the term. A final credit score is calculated in accordance with the quality of the payback record as related to the payback schedule. A new interest amount is calculated based on the final credit score. A cash rebate is issued to the borrower as the difference between the initial interest amount and the final interest amount. This invention clearly distinguishes over the sited prior art described above in the description of prior art. For instance, Kern et al teaches a reduction in a loan amount by those making certain purchases in accordance with the wishes of the lending institution. Sanchez et al describes a loan program which adjusts the loan parameters in accordance with its payback record but such adjustments are completed during the payback period and do not offer a post loan payoff cash rebate. The present invention distinguishes over this by offering a cash rebate to the lender at the end of the loan term depending on compliance with the terms of the loan payback. Since interest rates vary by the credit score of borrowers, they typically range presently from about 5 percent to about 20 percent compounded daily. Depending on the term of a loan such variances in interest rates may cause a borrower with a low credit score to be forced to pay up to 10 times as much for the use of money as a borrower with a high credit score. However, the credit score is based on past performance and not the performance at present of a borrower. It assumes that the borrower will perform as in the past. The present invention gives the present borrower a chance to pay for the use of money at a level equal to the best credit score possible at the time of the loan by providing a cash rebate to the borrower of that portion of the interest already paid at the termination of the loan equal to the credit rating that such performance would correspond to. This difference has been found to more fully incentivize the borrower than merely receiving modifications in loan terms during the payback period as with Sanchez et al. Hucal discloses an automated method of setting up and maintaining revolving credit programs. Mumick et al., discloses a method and system of implementing a loan in a billing system that includes memory storing information relating to the loan, the information including a principal balance of the loan, a term of the loan, and an interest rate of the loan. King, discloses an operatively interconnected data processing and computing system that is provided for creating, servicing and paying loan agreements between a lender and borrower providing for repayment of the loan together with interest at a periodically adjusted rate based on the terms of the agreement. Shurling et al., discloses a relationship scoring and incentive reward awarding process that determines a relationship score for the relationships between a bank and each of its customers. Incentive rewards, such as reduced loan rates or increased deposit account interest, are awarded to customers based on the relationship scores. Kelly, discloses a computer-based method and system for controlling the mortgage rate charged to a mortgagee as a prevailing mortgage rate drops. The present invention provides a novel and highly effective incentive method for assuring prompt payment of a loan on a schedule which is not taught or suggested by the prior art.

A primary objective of the present invention is to provide an apparatus and method of use of such apparatus that yields advantages not taught by the prior art.

Another objective of the invention is to provide low cost loans to borrowers able to meet the terms of a payback schedule.

A further objective of the invention is to incentivize such borrowers to meet the highest requirements of such payback schedules.

A still further objective of the invention is to prevent the poor payback records of some borrowers from effecting the borrowing opportunities of those that are able to meet payback commitments.

Another objective of the invention is to enable those with poor payback records in past transactions to not be penalized when they are able to meet current commitments in loan payback.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWING

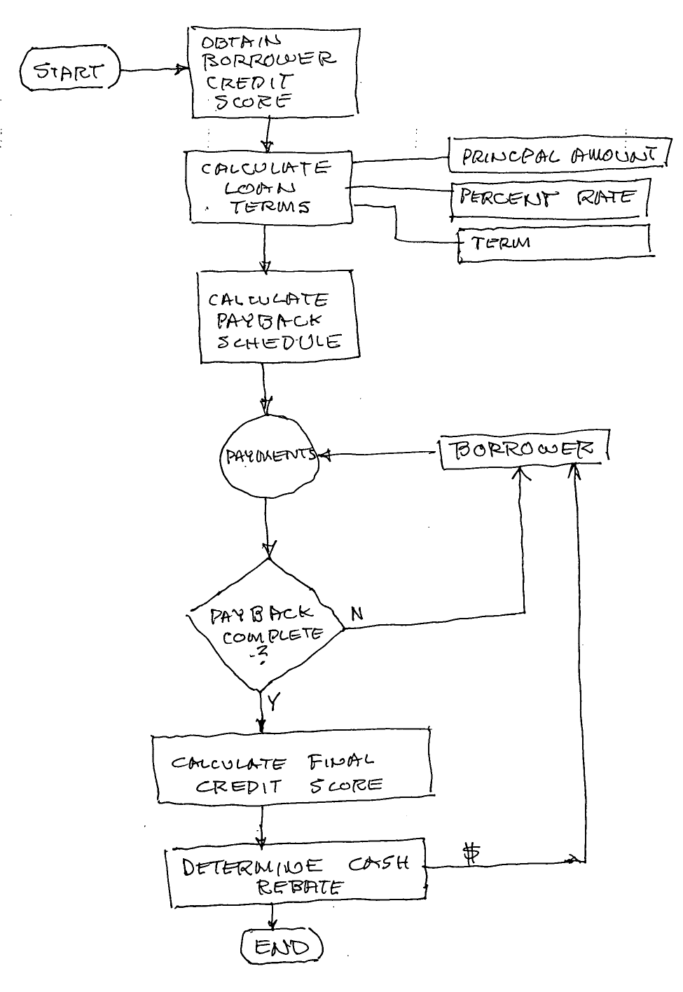

The accompanying drawing illustrates a best mode embodiment of the present invention. In such drawing FIG. 1 is a flow diagram of the preferred method of one embodiment of the invention.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

In one embodiment of the present invention, a method provides a cash rebate in a loan program of a financial institution using a computer having a memory device. The method includes maintaining, in the memory device of the computer, for each borrower, a borrower information file, including a contractual loan payback schedule based on an interest rate calculated in accordance with a current credit score of the borrower. A principal amount, an initial interest amount, and a loan term are agreed upon by the institution and the borrower. Payback transaction data is stored in the memory device of the computer during the loan term as the loan is paid off including interest and principal. The transaction data is compiled as a payback record at the end of the term. A final credit score is calculated in accordance with the quality of the payback record as related to the payback schedule. A new interest amount is calculated based on the final credit score. Finally, a cash rebate is issued to the borrower as the difference between the initial interest amount and the final interest amount.

In the United States, a borrower's credit rating is generally expressed as a FICO® score and this score ranges between 500 and 850, a unit-less number, depending on the borrower's credit history. For instance, at the present time, with a FICO® score below 559 an interest rate of 9.29% would be charged for long term borrowing. In contrast, with a score above 720, an interest rate of 5.63% would apply for the same loan. The difference in monthly payments between these two extremes is $374.00 on a 30 year $150,000.00 mortgage. In this case, the total rebate would amount to $134,640.00 over the term of the loan, which, surprisingly, is only slightly less than the full mortgage amount of $150,000.00. This example illustrates the great saving possible to a borrower through the application of a good credit rating and the very great incentive that is offered in the present invention when applying a credit rating based on the actual performance of the borrower rather on the borrower's past performance. It is clear that this greatly benefits the borrower, but it is also clear that this also benefits the lender who is more likely to experience fewer defaults on loans. Information about FICO® scores can be found on the Internet at www.myFICO.com.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor believes that the claimed subject matter is the invention.

What is claimed is:

1. A data processing method for providing a cash rebate in a loan program of a financial institution using a computer having a memory device; the method comprising the steps of:
a) maintaining, in the memory device of the computer, for a borrower, a borrower information file, including a contractual loan payback schedule based on an interest rate calculated in accordance with a current credit score of the borrower, a principal amount, an initial interest amount, and a term of the loan;
b) storing payback transaction data in the memory device of the computer during the term of the loan;
c) compiling the transaction data as a payback record at the end of the term of the loan;
d) calculating a final credit score in accordance with the quality of the payback record as compared to the payback schedule;
e) calculating a final interest rate based on the final credit score;
f) calculating a final interest amount based on the final interest rate;
f) issuing a cash rebate to the borrower as the difference between the initial interest amount and the final interest amount.
